(19) United States
(12) Patent Application Publication
(10) Pub. No.: US 2006/0200553 A1
(43) Pub. Date: Sep. 7, 2006

(54) PATH SEARCHING METHOD OF A WIRELESS COMMUNICATION SYSTEM AND PATH SEARCHING APPARATUS THEREOF

(76) Inventor: Jian Xu, Suzhou City, Jiansu Province (CN)

Correspondence Address: NORTH AMERICA INTELLECTUAL PROPERTY CORPORATION, P.O. BOX 506, MERRIFIELD, VA, 22116, US

(21) Appl. No.: 11/164,972

(22) Filed: Dec. 13, 2005

(30) Foreign Application Priority Data
Dec. 14, 2004 (TW) 093138798

(51) Int. Cl. G06F 15/173

(52) U.S. Cl. 709/224

(57) ABSTRACT

A path searching method for detecting a plurality of received signals according to a multipath signal, wherein the multipath signal is received under a multipath propagation. The path searching method includes determining a first detected path according to a maximum peak value of the multipath signal, determining a second detected path according to the multipath signal and the first detected path, and generating a first receiving path and a second receiving path according to the first detected path and the second detected path, wherein the second detected path corresponds to a second maximum peak value of the multipath signal.

### BACKGROUND OF THE INVENTION

1. Field of the Invention

The invention relates to a method and apparatus for searching the paths of signal propagation, and more particularly, to a path searching method of a wireless communication system for improving the multi-path propagation mechanism and apparatus thereof.

2. Description of the Prior Art

Recently, the CDMA communication system became a key issue due to the increasing popularity of the personal mobile communication system. However, the phenomenon of multi-path fading in a mobile communication system significantly affects the quality of communication. In general, the rake receiver is typically utilized in the mobile communication system to overcome the negative influence of the multipath fading.

The basic operation scheme of the rake receiver is described here. The rake receiver utilizes a plurality of rake tracing units to receive the received signals detected from a plurality of paths. A propagation signal passes through different paths then ultimately is received by the rake receiver. The delayed times are different because the rake receiver receives the fading signal generated by the propagation signal passing through different paths at different times. When this operation is viewed graphically with respect to a time axis, the received signals received from the rake receiver appear to look like a rake with multiple teeth. Each tooth (i.e., namely the peak of a received signal) represents the fading signal, which is generated after the data is transferred through a path.

Please refer to FIG. 1 and FIG. 2. FIG. 1 is a schematic diagram of the conventional propagation signal 20. FIG. 2 is a scheme diagram of the received signal 21 corresponding to the propagation signal 20 in FIG. 1. The propagation signal 20 is utilized to transfer the data. Please note, there is a peak value of the propagation signal 20 at time t₀. While the propagation signal 20 is transferred to a conventional rake receiver through three different paths, the propagation signal 20, which passes through three different paths, will generate the received signal 21 with three different peak values and different delay times respectively. Further, the conventional rake receiver then determines the number of paths according to the number of peak values of the received signal 21. Next, the conventional rake receiver performs a more precise detection operation at times t₁, t₂, and t₃ to seize three received signals corresponding to different paths with higher resolution. Usually, the conventional rake receiver utilizes a searcher to roughly detect the peak value of the received signal and determines a predetermined number of the path according to the location of the peak value. The rake receiver then assigns each path to each rake tracing unit to detect the received signals more precisely. Finally, the signals received by each rake tracing unit are supplemented in order to reconstruct the original propagation signal and data.

However, while the signal intensity from one receiving path of above-mentioned received signal 21 is obviously stronger then other receiving paths, the signal corresponding to this received path may affect other signals from other receiving paths. In this case, the method of determining the receiving path by using the peak-value mechanism will cause an inaccuracy. The will result in the rake receiver assigning the wrong path information to the rake tracing unit. Further considered that, when the received time of two signal peak values corresponding to two different receiving paths is sufficiently short (i.e., too small), the mutual-influence will also cause an inaccuracy during the process of determining receiving paths. In order to solve this problem, the system needs to enlarge the detect range of the rake tracing unit. As a result, there will be an increase in the load of the following operations to maintain the accuracy of the rake receiver.

### SUMMARY OF THE INVENTION

One of many objectives of the invention is to provide a path searching method which improves the multi-path propagation mechanism for decreasing the operation amount of path searching and retains a better accuracy, in order to solve the above-mentioned question.

According to an aspect of the present invention, a path searching method is disclosed. The path searching method is capable of detecting a plurality of received signals according to a multipath signal, wherein the multipath signal is received under a multipath propagation, the path searching method comprising: determining a first detected path according to a maximum peak value of the multipath signal; determining a second detected path according to the multipath signal and the first detected path; and generating a first receiving path and a second receiving path according to the first detected path and the second detected path; wherein the second detected path corresponds to a second maximum peak value of the multipath signal.

According to another aspect of the present invention, a path searching apparatus is disclosed. The path searching apparatus is capable of detecting a plurality of received signals according to a multipath signal, wherein the multipath signal is received under a multipath propagation, the path searching apparatus comprising: a receiving module for determining a first detected path according to a maximum peak value of the multipath signal and determining a second detected path according to the multipath signal and the first detected path; and an initial searching module couple to the receiving module for generating a first receiving path and a second receiving path according to the first detected path and the second detected path.

The invention of path searching method and apparatus can determine a second detected path by utilizing feedback mechanism after determining a first detected path, and decrease the operation amount of path searching meanwhile maintaining a superior accuracy.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the conventional propagation signal.

FIG. 2 is a schematic diagram of the received signal corresponding to the propagation signal in FIG. 1.

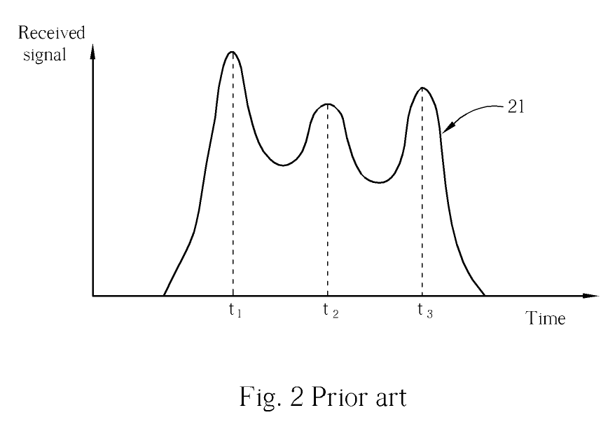

FIG. 3 shows a flowchart of one embodiment of the path searching method.

FIG. 4 is a block diagram of the path searching apparatus according to an embodiment of the present invention.

### DETAILED DESCRIPTION

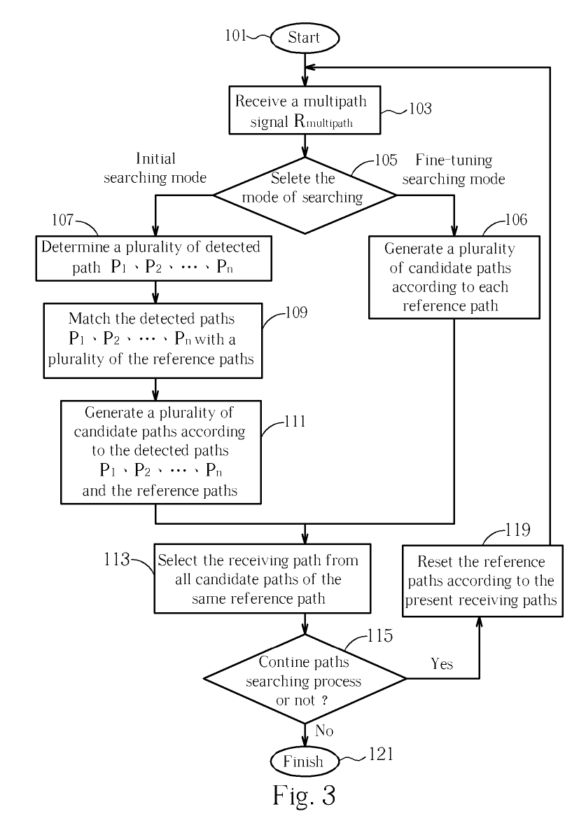

Please refer to FIG. 3. FIG. 3 shows a flowchart of one embodiment of the path searching method. The path searching method in the present invention refers to a rake receiver applied with code division multiplex access (CDMA). The operation steps are as follows:

Step 101: Start.

Step 103: Receive a multipath signal Rₘᵤₗₜᵢₚₐₜₕ.

Step 105: Select the mode of searching, if the initial searching mode is selected, then go to step 107; if the fine-tuning searching mode is selected, then go to step 106.

Step 106: Generate a plurality of candidate paths according to each reference path, and then go to step 113.

Step 107: Determine the first detected path P₁ according to the maximum peak value of the multipath signal Rₘᵤₗₜᵢₚₐₜₕ, and determine the following detected paths P₂, P₃, . . . , Pₙ by utilizing the feedback mechanism.

Step 109: Match the detected paths P₁, P₂, . . . , Pₙ with a plurality of the reference paths.

Step 111: Generate a plurality of candidate paths according to the detected paths P₁, P₂, . . . , Pₙ and the corresponding reference paths.

Step 113: Calculate the correlation values between all candidate paths of the same reference path and a predetermined signal, and select the candidate path with the highest correlation values as the receiving path.

Step 115: Determine whether to continue the paths searching process? If yes, go to step 119; otherwise go to step 121.

Step 119: Reset the reference paths according to the present receiving paths then go back to step 103.

Step 121: Finish.

As shown in FIG. 3, when the rake receiver receives a multipath signal Rₘᵤₗₜᵢₚₐₜₕ the searcher of the rake receiver first needs to select one mode of path searching. If the initial searching mode is selected first the searcher will detect the maximum peak value of the multipath signal Rₘᵤₗₜᵢₚₐₜₕ, and set the time corresponding to the maximum peak value as a detected path P₁. The searcher detects a received signal from the multipath signal Rₘᵤₗₜᵢₚₐₜₕ according to the detected path P₁ and reconstructs the received signal. Accordingly, the searcher removes the components of the received signal from the multipath signal Rₘᵤₗₜᵢₚₐₜₕ and detects the maximum peak value of multipath signal Rₘᵤₗₜᵢₚₐₜₕ again and then sets the time corresponding to the second maximum peak value as a detected path P₂. The process described above is then repeated to determine all detected path P₃, . . . , Pₙ of multipath signal Rₘᵤₗₜᵢₚₐₜₕ. The above-mentioned repeat process is in fact the feedback mechanism of step 107.

Please note that, the signal that is received and dispatched by the signal code division multiplex access (CDMA) is highly related to a predetermined signal (e.g., a pseudo sequence). Because of this relationship, the path searching method of the present invention can further generate a complementary path Pₙ₊₁ as a detected path after determining the detected path P₁, P₂, . . . , Pₙ. Additionally, the correlation between the signal in the complementary path Pₙ₊₁ and the predetermined signal is very small (e.g., less then 0.1). Therefore, when the number of detected paths determined by the searcher is less then the predetermined number of detected paths in the searcher, the complementary path Pₙ₊₁ can be utilized to solve the lack of a path number. That is, the complementary path Pₙ₊₁ can avoid the rake receiver from importing the wrong path information that would further affect the operational accuracy of the rake receiver.

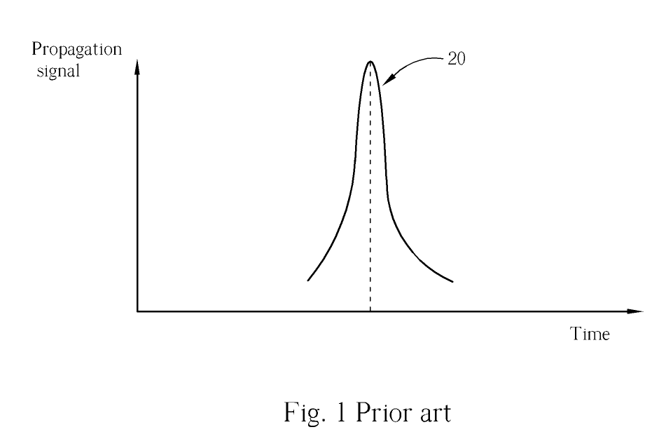

After determining the detected paths, the searcher matches the reference paths with the detected paths P₁, P₂, . . . , Pₙ (step 109). The number of the reference paths and the detected paths should be the same. In general, the receiving paths generated from the last path searching process are perceived as the reference paths. If the initial search mode has no previous record for reference, then the matching process can be omitted and simply proceed directly to step 111. For instance, assume the number of the detected paths and the reference paths are both three (e.g., namely n=3), the reference paths are {0, 8, 16} and the detected paths are {7, 16, 1}. Meanwhile both {7, 16, 1} and {0, 8, 16} represent the received time spot corresponding to the paths, which are namely time t₁, t₂, t₃ of FIG. 1, and rank the paths according to the peak value. Therefore the signal intensity corresponding to the reference path {0} is the highest, the reference path {8} is the next highest, and the reference path {16} is the lowest. Additionally, the representation of the detected paths follows this same theorem.

The path searching method in this invention will match the detected paths {7, 16, 1} with the reference paths {0, 8, 16} appropriately. That is, the detected path {1} corresponds to the reference path {0}; the detected path {7} corresponds to the reference path {8}; and the detected path {16} corresponds to the reference path {16}. Then, the detected path and its corresponding reference path are expanded to a plurality of candidate paths respectively. Assuming each candidate path is added to both the left side and right side of the detected path and the reference path. That is, the candidate path {−1, 0, 1, 2} is generated by the detected path {1} and the reference path {0}; The candidate path {6, 7, 8, 9} is generated by the detected path {7} and the reference path {8}; and the candidate path {15, 16, 17} is generated by the detected path {16} and the reference path {16}. In the conventional art, the candidate path is not generated through the arrangement process of detected paths, thus the number of the candidate paths will increase substantially. As shown in the above example, but utilizing the conventional skill, the detected path {7} matches with the reference path {0} to generate the candidate path {−1, 0, 1, 5, 6, 7, 8}; the detected path {16} matches with the reference path {8} to generate the candidate path {7, 8, 9, 10, 15, 16, 17}; and the detected path {1} matches with the reference path {16} to generate the candidate path {−1, 0, 1, 2, 15, 16, 17}. Obviously, the number of the candidate paths, which is generated by the path searching method in the represent invention, is much less than the number of the candidate paths generated by the conventional skill.

In this preferred embodiment, the way of matching the detected path with the reference path is done so by subtracting the reference paths {0, 8, 16} from the detected paths {7, 16, 1} alternately and taking the absolute value of the result. The detail operation can be expressed as follows:

$$[ \begin{matrix}\vert 7 - 0 \vert & \vert 16 - 0 \vert & \vert 1 - 0 \vert \\ \vert 7 - 8 \vert & \vert 16 - 8 \vert & \vert 1 - 8 \vert \\ \vert 7 - 16 \vert & \vert 16 - 16 \vert & \vert 1 - 16 \vert\end{matrix} ] = [ \begin{matrix}7 & 16 & 1 \\ 1 & 8 & 7 \\ 9 & 0 & 15\end{matrix} ] \qquad Formula 1$$

Now, using the result above, locate the smallest element (i.e., find the smallest number or in other words the number with the least value). The element identified as the smallest in value is copied directly as shown below on the left side. Additionally, all elements (i.e., numbers) that are in the same row and the same column as the element that was identified as being the smallest element are switched to a maximum value (e.g., 100) of 100 as is shown below on the left side. Next, perform the same procedure a second time. The result is shown below to the right. Please note that in the case where more than a single smallest number exists (i.e., the smallest number appears more than once) using any one of those smallest numbers satisfies the operation. The results can be obtained as the following:

$$[ \begin{matrix}7 & 100 & 1 \\ 1 & 100 & 7 \\ 100 & 0 & 100\end{matrix} ] ⇒ [ \begin{matrix}100 & 100 & 1 \\ 1 & 100 & 100 \\ 100 & 0 & 100\end{matrix} ]$$

Please noted that the value “0”, “1”, and “1” are generated from the value “16-16”, “7-8”, and “1-0”, therefore it is known that the detected path {16} is corresponding to the reference path {16}; the detected path {7} is corresponding to the reference path {6}; and the detected path {1} is corresponding to the reference path {0}.

Next, the searcher proceeds with the correlation calculation toward all candidate paths, and selects the highest correlation candidate path from all candidate paths corresponding to the same detected path as a receiving path. Then the searcher assigns each receiving path, which is corresponding to the detected path, to the rake tracing unit respectively for executing the following detection process and, finally, resets the reference paths utilized by next searching process according to the present receiving paths. Since the method of selecting one receiving path from a plurality of candidate paths is considered well known in the pertinent art and further details are therefore omitted for brevity.

If the fine-tuning search mode is selected, the searcher will omit the step of generating the detected path according to the peak value, and directly extend each reference path to a plurality of candidate paths (step 106). The advantage of the fine-tuning search mode is that when the result of each detection process may not change significantly, the known reference path can be directly utilized to search for a better receiving path. The system can be designed to randomly perform either the initial search mode or the fine-tuning search mode, or determine the desired search mode according to the Signal to Noise Ratio (SNR) of the following detection, or it can even determine the initial search mode or the fine-tuning search mode by a predetermined ratio and adjust the ratio according to the SNR of the following detection. All of above-mentioned methods are within the scope of this invention.

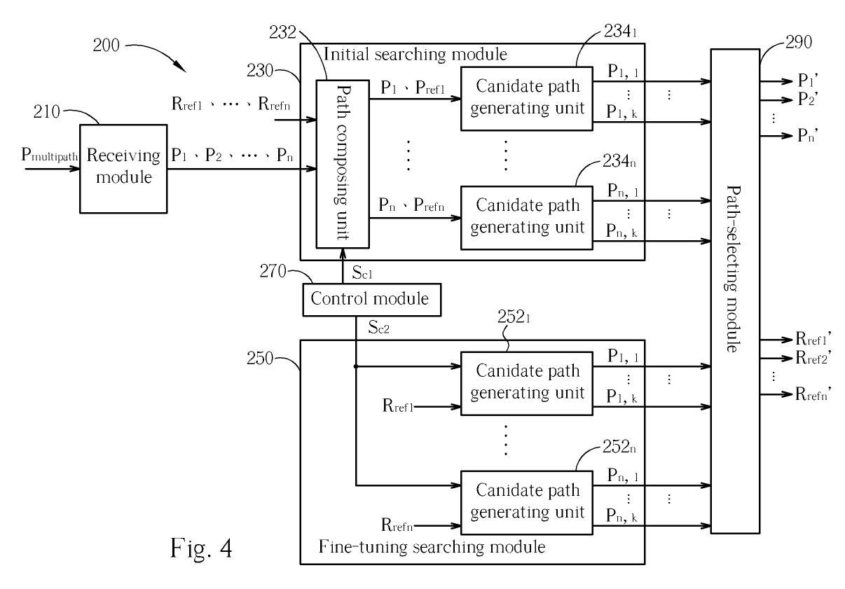

Please refer to FIG. 4. FIG. 4 is a block diagram of the path searching apparatus 200 according to an embodiment of the present invention. The path search apparatus 200 is utilized for performing the above-mentioned path searching method. As shown in FIG. 4, the path search apparatus includes a receiving module 210, an initial searching module 230, a fine-tuning searching module 250, a control module 270, and a path-selecting module 290. The control module 270 is utilized for sending a control signal Sc₁ to enable the initial searching module 230 or sending a control signal Sc₂ to enable the fine-tuning searching module 250. The initial searching module 230 includes a path composing unit 232 and a plurality of candidate path generating units 234₁, . . . , 234ₙ. The fine-tuning searching module 250 includes a plurality of candidate path generating units 252₁, . . . 252ₙ. The receiving module 210 is utilized for generating the detected paths P₁, P₂, . . . , Pₙ according to the multipath signal Rₘᵤₗₜᵢₚₐₜₕ and sending the detected paths P₁, P₂, . . . , Pₙ to the initial searching module 230. The path composing unit 232 matches the detected paths P₁, P₂, . . . , Pₙ with a plurality of reference paths P_{ref1}, P_{ref2}, . . . , P_{refn}, and sends the result to a plurality of candidate path generating units 234₁, . . . , 234ₙ. Then the candidate path generating units 234₁, . . . , 234ₙ generate a plurality of candidate paths P_{1,1}, P_{1,2}, . . . , P_{1,k}, . . . P_{n,1}, P_{n,2}, . . . , P_{n,k} according to the inputted reference paths and detected paths. And the candidate path generating units 252₁, . . . , 252ₙ generate a plurality of candidate paths P_{1,1}, P_{1,2}, . . . , P_{1,k}, . . . , P_{n,1}, P_{n,2}, . . . , P_{n,k} by utilizing the reference paths P_{ref1}, P_{ref2}, . . . , P_{refn} directly. Lastly, the path-selecting module 290 selects the receiving paths P₁′, P₂′, . . . , Pₙ′ form the candidate paths P_{1,1}, P_{1,2}, . . . , P_{1,k}, . . . , P_{n,1}, P_{n,2}, . . . , P_{n,k} and generates the reference path P_{ref1}′, P_{ref2}′ . . . , P_{refn}′ for next path searching process from the receiving paths P₁′, P₂′, . . . , Pₙ′.

In contrast to the related art, the path searching method and the related apparatus of the present invention for generating a plurality of detected paths by utilizing feedback mechanism provide improved stability and accuracy of path searching process. Meanwhile the path searching method and the related apparatus of the present invention are capable of decreasing the number of the candidate paths and substantially reducing the operation load of the rake receiver by utilizing the method of matching the reference paths with the detected paths.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A path searching method for detecting a plurality of received signals according to a multipath signal, wherein the multipath signal is received under a multipath propagation, the path searching method comprising:
determining a first detected path according to a maximum peak value of the multipath signal;
determining a second detected path according to the multipath signal and the first detected path; and
generating a first receiving path and a second receiving path according to the first detected path and the second detected path;
wherein the second detected path corresponds to a second maximum peak value of the multipath signal.

2. The path searching method of claim 1 wherein the step of determining the second detected path further comprises:
reconstructing a first received signal corresponding to the first detected path;
removing the first received signal from the multipath signal to generate a remaining signal; and
determining the second detected path according to a maximum peak value of the remain signal.

3. The path searching method of claim 1 wherein the step of generating the first receiving path and the second receiving path further comprises:
selecting a reference path which is most similar to the first detected path from a plurality of reference paths to be a first reference path;
selecting a reference path which is most similar to the second detected path from a plurality of reference paths to be a second reference path;
generating a plurality of first candidate paths according to the first detected path and the first reference path, and determining the first receiving path from the first candidate paths; and
generating a plurality of second candidate paths according to the second detected path and the second reference path, and determining the second receiving path from the second candidate paths.

4. The path searching method of claim 3 wherein the step of determining the first receiving path and the second receiving path is performed when the Signal to Noise Ratio (SNR) of the last path searching process is less than a predetermined value.

5. The path searching method of claim 3 wherein the step of determining the first receiving path further comprises:
calculating a plurality of correlation values between the first candidate paths and a predetermined signal, and determining the first receiving path from the first candidate paths according to the maximum correlation value of the first candidate paths; and
wherein the step of determining the second receiving path further comprises:
calculating a plurality of correlation values between the second candidate paths and a predetermined signal, and determining the second receiving path from the second candidate paths according to the maximum correlation value of the second candidate paths.

6. The path searching method of claim 1 wherein the step of generating the first receiving path and the second receiving path further comprises:
generating a plurality of first candidate paths according to a reference path in a plurality of reference paths, and determining the first receiving path from the first candidate paths; and
generating a plurality of second candidate paths according to a reference path in a plurality of reference paths, and determining the second receiving path from the second candidate paths.

7. The path searching method of claim 6 wherein the step of determining the first receiving path and the second receiving path is performed when the error rate of the last path searching process is not less than a predetermined value.

8. The path searching method of claim 6 wherein the step of determining the first receiving path further comprises:
calculating a plurality of correlation values between a plurality of first signals corresponding to the first candidate paths and a predetermined signal, and determining the first receiving path from the first candidate paths according to the maximum correlation value of the of first signals; and
wherein the step of determining the second receiving path further comprises:
calculating a plurality of correlation values between a plurality of second signals corresponding to the second candidate paths and a predetermined signal, and determining the second receiving path from the second candidate paths according to the maximum correlation value of a plurality of second signals.

9. The path searching method of claim 2 wherein the step of determining the second detected path further comprises:
generating a third detected path according to a complementary path;
wherein the correlation value between the third detected path corresponding to the complementary path and a predetermined value is less than a threshold value.

10. The path searching method of claim 1 wherein the path searching method is utilized with a code division multiplex access (CDMA).

11. A path searching apparatus for detecting a plurality of received signals according to a multipath signal, wherein the multipath signal is received under a multipath propagation, the path searching apparatus comprising:
a receiving module for determining a first detected path according to a maximum peak value of the multipath signal and determining a second detected path according to the multipath signal and the first detected path; and
an initial searching module coupled to the receiving module for generating a first receiving path and a second receiving path according to the first detected path and the second detected path.

12. The path searching apparatus of claim 11 wherein the receiver module removes the received signal corresponding to the first detected path from the multipath signal to generate a remaining signal, and determining the second detected path according to the maximum peak value of the remaining signal.

13. The path searching apparatus of claim 11 wherein the initial searching module further comprises:
a path composing unit couple to the receiving module for selecting a reference path which is most similar to the first detected path from a plurality of reference paths to be a first reference path, and selecting a reference path which is most similar to the second detected path from a plurality of reference paths to be a second reference path;
a first candidate path generating unit couple to the receiving module and the path composing unit for generating a plurality of first candidate paths according to the first detected path and the first reference path, and determining the first receiving path from the first candidate paths; and
a second candidate path generating unit couple to the receiving module and the path composing unit for generating a plurality of second candidate paths according to the second detected path and the second reference path, and determining the second receiving path from the second candidate paths.

14. The path searching apparatus of claim 13 wherein the first candidate path generating unit determines the first receiving path according to a plurality of correlation values between the first candidate paths and a predetermined signal; and the second candidate path generating unit determines the second receiving path according to a plurality of correlation values between the second candidate paths and a predetermined signal.

15. The path searching apparatus of claim 13 wherein the path searching apparatus further comprises:
a fine-tuning searching module for generating the first candidate paths according to a reference path in a plurality of reference paths and determining the first receiving path from the first candidate paths, and generating the second candidate paths according to a reference path in a plurality of reference paths and determining the second receiving path from the second candidate paths; and
a control module for enabling the fine-tuning searching module or the initial searching module selectively.

16. The path searching apparatus of claim 15 wherein the fine-tuning searching module further comprises:
a first candidate path generating unit for determining the first receiving path according to a plurality of correlation values between the first candidate paths and a predetermined signal; and
a second candidate path generating unit for determining the second receiving path according to a plurality of correlation values between the second candidate paths and a predetermined signal.

17. The path searching apparatus of claim 11 wherein the initial searching module generates a third detected path according to a complementary path;
wherein the correlation value between the third detected path corresponding to the complementary path and a predetermined value is less than a threshold value.

18. The path searching apparatus of claim 11 wherein the path searching apparatus is utilized with a code division multiplex access (CDMA).
